(19) United States
(12) Patent Application Publication
(10) Pub. No.: US 2016/0160527 A1
(43) Pub. Date: Jun. 9, 2016

(54) MECHANICAL MODULE AND KEY

(71) Applicant: JOHNSON CONTROLS AUTOMOTIVE ELECTRONICS SAS, Cergy-Pontoise Cedex (FR)

(72) Inventor: Didier Pozzi, Ermont (FR)

(21) Appl. No.: 14/902,003

(22) PCT Filed: Jul. 2, 2014
(86) PCT No.: PCT/EP2014/064029

§ 371 Date: Feb. 19, 2016

(30) Foreign Application Priority Data
Jul. 2, 2013 (FR) 13 01560

(51) Int. Cl. E05B 19/00; E05B 85/00

(52) U.S. Cl. CPC E05B 19/0082; E05B 19/00; E05B 85/00

(57) ABSTRACT

A mechanical module includes: a body; an insert; first fixing means; and second fixing means. The insert and the body are configured to be attached together via a relative movement substantially parallel to the primary extension direction of the insert. The first fixing means includes: a first wall inclined relative to the primary extension direction; and a second wall substantially perpendicular to the primary extension direction. The second fixing means includes a hook element, the hook element including a bearing element and a lug element. The bearing and lug elements are configured to ensure, in cooperation with the first and second wails, mechanical fixing of the insert to the body, via the bearing element in cooperation with the first wall and the lug element in cooperation with the second wall.

### CROSS-REFERENCE TO RELATED APPLICATIONS

This application is a U.S. National Phase application under 35 U.S.C. §371 of International Application No. PCT/EP2014/064029, filed on Jul. 2, 2014, and claims benefit to French Patent Application No. FR 13 01560, filed on Jul. 2, 2013. The International Application was published in French on Jan. 8, 2015 as WO 2015/000940 A1 under PCT Article 21(2).

### FIELD

The present invention concerns a mechanical module, in particular for a key of a vehicle, and a key.

### BACKGROUND

Vehicle keys are generally known. They are intended in particular for locking and unlocking opening panels of the vehicle, for example, such as doors, for example, operating a rear hatch, an antitheft device and/or a starter motor of the vehicle.

Also known are vehicle keys that include a key body forming a housing, for example for electronic means for remote control of locking means of the opening panels of the vehicle. The housing is often produced in two parts, each of which forms approximately half of the housing.

The housing is in particular held by the user and the electronic means for remote control of the locking means of the opening panels of the motor vehicle are intended to cooperate with a receiver positioned inside the motor vehicle.

Moreover, known keys include an insert mounted on the key body. The insert may be fixedly fixed to the key body or to the mechanical module, i.e. the insert is positioned in a fixed manner relative to the mechanical module. In an alternative implementation, the key body may be such that the insert can be pivoted about a rotation axis of the insert, in particular between a position of use, on the one hand, and a stowage position, on the other hand.

In all cases, the insert must be fixed to the mechanical module in a reliable and robust manner. The insert is in particular intended to implement the ignition key function of the motor vehicle, for example to unlock the steering wheel.

In the known implementations, such an insert may be fixed by means of a screw cooperating with a threaded hole, for example.

### SUMMARY

In an embodiment, the invention provides a mechanical module, the mechanical module comprising: a body; an insert; first fixing means; and second fixing means. The insert has an oblong shape and extends in a primary extension direction, and has a first end part and a second end part, the end parts of the insert being opposite each other in the primary extension direction of the insert. The first end part of the insert is configured for mechanical interaction with a lock of the motor vehicle. The second end part of the insert is configured to be permanently attached to the body via the first and second fixing means. The body includes a slot, and the insert includes a flat part at the second end part. The insert and the body are configured to be attached together via a relative movement substantially parallel to the primary extension direction of the insert. The first fixing means includes: a first wall inclined relative to the primary extension direction; and a second wall substantially perpendicular to the primary extension direction. The second fixing means includes a hook element, the hook element including a bearing element and a lug element. The bearing and lug elements are configured to ensure, in cooperation with the first and second walls, mechanical fixing of the insert to the body, via the bearing element in cooperation with the first wall and the lug element in cooperation with the second wall.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a diagrammatic view of a motor vehicle key in accordance with an embodiment the present invention, the key including an insert, and the insert, in particular a metal insert, is connected to the key in a fixed manner.

FIG. 2 is a diagrammatic detail perspective view of the fixing of the insert to the housing of the key.

FIG. 3 is a diagrammatic front view showing the fixing of the insert to the mechanical module of the key.

FIG. 4 is a diagrammatic sectional view showing the fixing of the insert to the mechanical module of the key.

### DETAILED DESCRIPTION

A disadvantage of the aforementioned prior art keys is the necessity to have to attach the screw. Such an implementation requires a process of assembly of the key with a relatively higher unit cost: the fact of having to produce the threaded hole in the housing is costly, and it is difficult to design an automated process that makes it possible to use the screw to fix the insert.

In an embodiment, the present invention alleviates the disadvantages of the prior art, and in particular those cited above, and provides a mechanical module, in particular for a key of a vehicle, that is of relatively low cost but nevertheless enables reliable and stable fixing of the insert relative to the mechanical module of the motor vehicle key.

In an embodiment, the invention provides a mechanical module, in particular for a key and in particular for controlling functionalities of a motor vehicle, the mechanical module including a body, the mechanical module also including an insert, the mechanical module and the insert including first fixing means and second fixing means,

the insert having an oblong shape and extending in a primary extension direction, the insert having a first end part and a second end part, the end parts of the insert being opposite each other in the primary
extension direction of the insert,
the first end part of the insert being designed for mechanical interaction with a lock of the motor vehicle,
the second end part of the insert being designed to be permanently attached to the mechanical module via the first and second fixing means, the mechanical module including a slot and the insert including a flat part in its second end part,
the insert and the mechanical module being attached together via a relative movement essentially parallel to the primary extension direction of the insert, the first fixing means including:
a first wall inclined relative to the primary extension direction, and
a second wall essentially perpendicular to the primary extension direction, and the second fixing means including a hook element including:
a bearing element, and
a lug element,
   the bearing and lug elements ensuring, in cooperation with the first and second walls, the mechanical fixing of the insert to the mechanical module, the bearing element in cooperation with the first wall, and the lug element with the second wall.

It is therefore advantageously possible to produce the housing of the mechanical module so that it is possible to fix the insert in a simple and effective manner, via a process that is simple to automate.

In accordance with the present invention, the key body in particular forms a housing for an electronic control unit for remotely unlocking or locking of the opening panels of the vehicle. In particular, it is possible in accordance with the present invention for the housing to be made in two parts each of which forms approximately half of the housing.

In accordance with the present invention, the housing is typically held by the user and the electronic control unit is intended to cooperate with a receiver that is positioned inside the motor vehicle.

In an exemplary embodiment, the lug element bears progressively on the first wall during the relative movement of attachment between the insert and the mechanical module.

By virtue of such an implementation, it is advantageously possible to connect the insert to the mechanical module in a simple and effective manner.

In particular, it is preferable for the insertion force when mounting the insert in the mechanical module (or with the mechanical module) to increase progressively, as a function of the bearing force of the lug element against the first wall during the attachment movement.

It is therefore advantageously possible in accordance with the present invention to prevent malfunctions during the assembly process.

In an exemplary embodiment, the mechanical module includes the first fixing means and the insert includes the second fixing means.

By such an implementation, it is advantageously possible in accordance with the present invention for the slot of the mechanical module to include the first and second walls.

In an exemplary embodiment, the body includes a first body part and a second body part, the first and second body parts being mechanically fixed together.

It is therefore advantageously possible to assemble the key body in a simple and effective manner.

In an exemplary embodiment, the insert is attached to the key body or to the mechanical module in a fixed manner, i.e. the insert is positioned in a fixed manner relative to the mechanical module.

In accordance with a preferred embodiment of the present invention, the key body is such that the insert can be pivoted about a rotation axis of the insert, in particular between a position of use, on the one hand, and a stowage position, on the other hand. In such an embodiment, the key body or the mechanical module includes a rotary element that includes the slot and—during assembly of the key or of the mechanical module—the second end part of the insert is inserted into the slot of the rotary element of the mechanical module.

In an exemplary embodiment, the first and second body parts are mechanically fixed together via a shape assembly that makes it possible to achieve great stability and reliability of the key body.

In an exemplary embodiment, the mechanical module includes at least one sealing element between the first body part and the printed circuit board.

By such an implementation it is advantageously possible to prevent external influences on the printed card, in particular moisture.

Moreover, the present invention also concerns a key, in particular a vehicle key, the key including a mechanical module in accordance with the present invention.

Other features and advantages of the invention will emerge on reading the following description of one particular nonlimiting embodiment of the present invention.

The invention will be better understood in the light of the following description, which refers to preferred embodiments provided by way of nonlimiting example and explained with reference to the appended diagrammatic drawings.

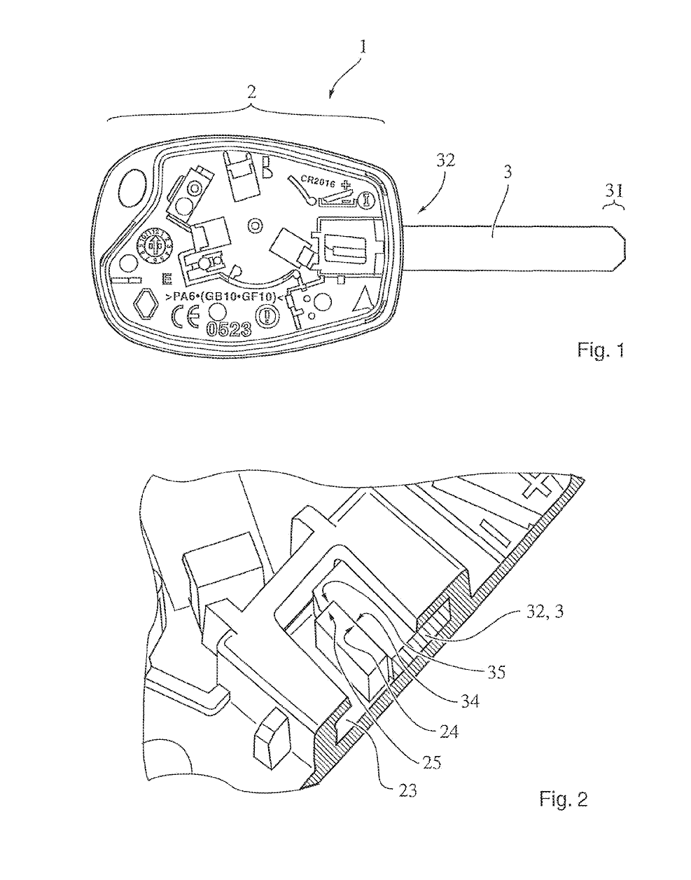

FIG. 1 shows by way of example a key 1 including a mechanical module in accordance with the present invention.

The key 1 is intended for locking and unlocking opening panels of the vehicle, and, for example, operating an antitheft device and a starter motor of the vehicle, etc.

In the example shown, the key 1 includes a key body 2, for example of clevis general shape. The key body 2 preferably includes a first part of a housing of the key body 2 and a second part of a housing of the key body 2.

The first and second parts are preferably manufactured by a molding process.

In accordance with the present invention, the key includes an insert 3. The insert is connected to the key body 2 either in a fixed manner or in a mobile manner, in particular so that it can be turned about an imaginary rotation (or pivot) axis.

When the insert 3 is mobile (in particular in rotation), the key body 2 may include a control button commanding the rotary movements of the insert 3 relative to the key body 2 about the imaginary rotation (or pivot) axis of the insert 3 relative to the key body 2. The rotary movement about the rotation axis enables movement of the insert 3 between a stowage and a position of use.

The insert 3, also referred to as a bit, has a plane general shape, for example. The insert typically has an oblong shape and extends in a primary extension direction. The insert 3 includes a first end part 31 and a second end part 32. The end parts 31, 32 of the insert 3 are opposite each other in the primary extension direction of the insert 3, i.e. one end of the insert 3 includes the first end part 31 and the opposite end of the insert 3 (in the primary extension direction) includes the second end part 32.

The first end part 31 of the insert 3 interacts mechanically with a lock of the motor vehicle. The second end part 32 of the insert 3 is designed to be permanently attached to the mechanical module 2 (or the key body 2) via the first and second fixing means.

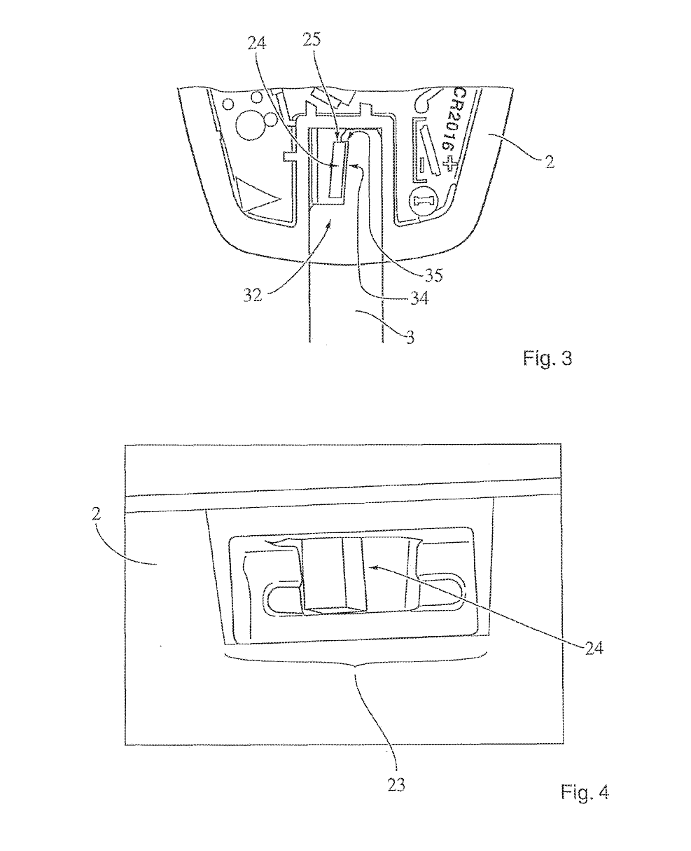

FIGS. 2, 3 and 4 are diagrammatic detail views showing the fixing of the insert to the housing of the key: FIG. 2 is a perspective view, FIG. 3 is a front view, and FIG. 4 is a sectional view showing the fixing of the insert to the mechanical module of the key.

The mechanical module 2 includes a slot 23 and the second end part 32 of the insert includes a flat portion that is inserted in the slot 23 during the process of assembling the insert with the key body 2. During this assembly process, the insert 3 and the mechanical module are attached together via a relative movement essentially parallel to the primary extension direction of the insert 3.

In accordance with the present invention, the first fixing means (in particular provided on the housing of the key) includes a first wall 24 inclined relative to the primary extension direction and a second wall 25 essentially perpendicular to the primary extension direction. Moreover, the second fixing means (in particular provided on the insert 3) includes a hook element which includes, on the one hand, a bearing element 34 and, on the other hand, a lug element 35.

In accordance with the present invention, in cooperation with the first and second walls 24, 25, the bearing and lug elements 34, 35 provide the mechanical fixing of the insert 3 to the mechanical module, the bearing element 34 in cooperation with the first wall 24, and the lug element 35 with the second wall 25.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A mechanical module, the mechanical module comprising:
a body;
second fixing means;
wherein the insert has an oblong shape and extends in a primary extension direction, and has a first end part and a second end part, the end parts of the insert being opposite each other in the primary extension direction of the insert;
wherein the first end part of the insert is configured for mechanical interaction with a lock of the motor vehicle;
wherein the second end part of the insert is configured to be permanently attached to the body via the first and second fixing means;
wherein the body includes a slot, and the insert includes a flat part at the second end part;
wherein the insert and the body are configured to be attached together via a relative movement substantially parallel to the primary extension direction of the insert;
Wherein the first fixing means includes:
a first wall inclined relative to the primary extension direction; and
a second wall substantially perpendicular to the primary extension direction;
wherein the second fixing means includes a hook element, the hook element including a bearing element; and a lug element;
wherein the second fixing means includes a hook element, the hook element including a bearing element; and a lug element
wherein the bearing and lug elements are configured to ensure, in cooperation with the first and second walls, mechanical fixing of the insert to the body, via the bearing element in cooperation with the first wall and the lug element in cooperation with the second wall.

2: The mechanical module according to claim 1, wherein the lug element is configured to bear progressively on the first wall during the relative attachment movement between the insert and the mechanical module.

3: The mechanical module according to claim 1, wherein the first fixing means is part of the body and the second fixing means is part of the insert.

4: The mechanical module according to claim 1, wherein the body includes a first body part and a second body part, the first and second body parts being mechanically fixed together.

5: The mechanical module according to claim 4, wherein the first and second body parts are mechanically fixed together via a shape assembly.

6: A vehicle key, comprising a mechanical module, the mechanical module comprising:
a body;
an insert;
first fixing means; and
second fixing means;
wherein the insert has an oblong shape and extends in a primary extension direction, and has a first end part and a second end part, the end parts of the insert being opposite each other in the primary extension direction of the insert;
wherein the first end part of the insert is configured for mechanical interaction with a lock of the motor vehicle;
wherein the second end part of the insert is configured to be permanently attached to the body via the first and second fixing means;
wherein the body includes a slot, and the insert includes a flat part at the second end part;
wherein the insert and the body are configured to be attached together via a relative movement substantially parallel to the primary extension direction of the insert;
wherein the first fixing means includes:
a first wall inclined relative to the primary extension direction; and
a second wall substantially perpendicular to the primary extension direction;
wherein the second fixing means includes a hook element, the hook element including a bearing element and a lug element;
wherein the bearing and lug elements are configured to ensure, in cooperation with the first and second walls, mechanical fixing of the insert to the body, via the bearing element in cooperation with the first wall and the lug element in cooperation with the second wall.

7. The vehicle key according to claim 6, wherein the lug element is configured to bear progressively on the first wall during the relative attachment movement between the insert and the mechanical module.

8. The vehicle key according to claim 6, wherein the first fixing means is part of the body and the second fixing means is part of the insert.

9. The vehicle key according to claim 6, wherein the body includes a first body part and a second body part, the first and second body parts being mechanically fixed together.

10. The vehicle key according to claim 9, wherein the first and second body parts are mechanically fixed together via a shape assembly.
